(19) United States
(12) Patent Application Publication
(10) Pub. No.: US 2026/0217270 A1
(43) Pub. Date: Jul. 30, 2026

(54) VEHICLE CONTROL DEVICE

(71) Applicant: TOYOTA JIDOSHA KABUSHIKI KAISHA, Toyota-shi (JP)

(72) Inventor: Yumi SHIMANAKA, Kasugai-shi (JP)

(73) Assignee: TOYOTA JIDOSHA KABUSHIKI KAISHA, Toyota-shi (JP)

(21) Appl. No.: 19/430,507

(22) Filed: Dec. 23, 2025

(30) Foreign Application Priority Data
Dec. 26, 2024 (JP) 2024-229919

(51) Int. Cl. B60W 50/12; B60W 10/18

(52) U.S. Cl. CPC B60W 50/12; B60W 10/18; B60W 2420/403; B60W 2420/408; B60W 2520/10; B60W 2520/30; B60W 2540/106; B60W 2552/15; B60W 2554/80; B60W 2556/40

(57) ABSTRACT

The vehicle control device executes a drive torque limitation process when a continuation time of a state in which a depression depth of an accelerator pedal or an increase rate thereof exceeds a threshold value is greater than an erroneous operation determination threshold value. The vehicle control device includes a sensor for acquiring a gradient difference which is a difference between a gradient of a region where a preceding moving body is located and a gradient of a region where an own vehicle is located, the gradients being of a road surface in a traveling direction of the own vehicle and the preceding moving body. The vehicle control device allocates a larger value to the erroneous operation determination threshold value as the gradient difference increases in a scene where the own vehicle enters an uphill road.

### BACKGROUND

The present invention relates to a vehicle control device that controls an own vehicle such that a drive torque applied to drive wheels of the own vehicle is limited to a predetermined value or less when it is determined that an accelerator pedal of the own vehicle is erroneously depressed.

### RELATED ART

A vehicle control device has been proposed that controls an own vehicle such that a drive torque applied to drive wheels of the own vehicle is limited to a predetermined value or less when it is determined that an accelerator pedal of the own vehicle is erroneously depressed (for example, see Patent Document 1 below.). A processor of this vehicle control device (hereinafter referred to as a “conventional device”) determines that the accelerator pedal has been erroneously depressed when, in a situation where a speed of the own vehicle is equal to or less than a threshold value and a distance between another vehicle (a preceding vehicle) positioned in front of the own vehicle and the own vehicle is equal to or less than a threshold value, an accelerator opening degree exceeds a threshold value. Then, in this case, the processor controls a drive device (a transmission) such that the drive torque applied to the drive wheels is equal to or less than a predetermined value (an upper limit value) (drive torque limitation process). As a result, a rapid increase (rapid acceleration) in the torque applied to the drive wheels of the own vehicle is suppressed, and a contact risk between the own vehicle and the preceding vehicle is reduced.

[Patent Document 1] Japanese Unexamined Patent Application Publication No. 2020-147142

### SUMMARY

Meanwhile, there is assumed a scene in which the own vehicle enters an uphill at a relatively low speed (a scene in which a road surface gradient increases (hereinafter referred to as an “uphill entry scene”)), and in which, so that sufficient drive torque is applied to the drive wheels for the own vehicle to start climbing the uphill smoothly (without the own vehicle being rapidly decelerated), a driver intentionally depresses the accelerator pedal relatively deeply. In this scene, it is preferable that the torque applied to the drive wheels is not limited to a predetermined value or less. However, the processor of the conventional device executes the drive torque limitation process when the above three conditions (a condition relating to the speed of the own vehicle, a condition relating to the distance between a preceding moving body and the own vehicle, and a condition relating to the accelerator opening degree) are satisfied, regardless of whether the current scene corresponds to the uphill entry scene or not. Therefore, according to the conventional device, in the uphill entry scene, there is a possibility that the torque of the drive wheels of the own vehicle is limited contrary to the driver's intention.

One object of the present invention is to provide a vehicle control device having a function of limiting, to a predetermined value or less, the torque of the drive wheels of the own vehicle when it is determined that the accelerator pedal has been erroneously depressed, the vehicle control device being capable of suppressing the torque of the drive wheels of the own vehicle from being limited to a predetermined value or less contrary to the driver's intention in a scene where the own vehicle enters an uphill.

To achieve the above object, a vehicle control device (1) of the present invention comprises:
an in-vehicle sensor (20) for acquiring information relating to a distance between a preceding moving body and an own vehicle, information relating to a speed of the own vehicle, and information relating to a depression operation of an accelerator pedal of the own vehicle; and
a processor (10) configured to execute a drive torque limitation process that controls a drive device and/or a braking device such that a drive torque applied to drive wheels of the own vehicle is limited to a predetermined value or less when, in a situation where a speed (sp0) of the own vehicle is equal to or less than a threshold value (sp0th) and a distance (Δd) between the own vehicle and the preceding moving body is equal to or less than a threshold value (Δdth), a continuation time (Δt) of a state in which a depression depth (AD) of the accelerator pedal or an increase rate (ADr) thereof exceeds a threshold value (ADth/ADrth) exceeds a predetermined erroneous operation determination threshold value (Δtth).

The in-vehicle sensor includes a sensor for acquiring a gradient difference which is a difference between a gradient of a region where the preceding moving body is located and a gradient of a region where the own vehicle is located, the gradients being of a road surface in a traveling direction of the own vehicle and the preceding moving body, and
the processor is configured such that, in a scene where the own vehicle enters an uphill, the larger the gradient difference, the larger a value is allocated to the erroneous operation determination threshold value.

When a speed of the own vehicle is relatively low and a distance between the own vehicle and a preceding moving body is relatively small, and a state in which the accelerator pedal is deeply depressed (or a state in which an increase rate of the depression depth is large) continues for a long time, there is a high possibility that the driver is erroneously depressing the accelerator pedal. Therefore, in this case, the processor of the vehicle control device according to the present invention executes the drive torque limitation process. As a result, the own vehicle is suppressed from excessively approaching the preceding moving body. Here, when the own vehicle starts climbing an uphill, there is a high possibility that the driver intentionally depresses the accelerator pedal deeply. In particular, when the gradient difference is relatively large, there is a high possibility that the driver depresses the accelerator pedal considerably deeply and maintains that state for a relatively long time. Therefore, the processor of the vehicle control device of the present invention allocates a larger value to the erroneous operation determination threshold value as the gradient difference becomes larger in a scene where the own vehicle enters an uphill. That is, a start timing of the drive torque limitation process is adjusted according to the gradient difference. And the larger the gradient difference, the larger a value is allocated to a delay time of the start timing of the drive torque limitation process. As a result, at a time when the own vehicle starts climbing the uphill (a time when the driver intentionally depresses the accelerator pedal deeply and immediately thereafter), execution of the drive torque limitation process contrary to the driver's intention is suppressed.

In a vehicle control device according to one aspect of the present invention, the processor is configured such that, in the scene, the greater the speed of the own vehicle at a time when the gradient difference is acquired, the smaller a value is allocated to the erroneous operation determination threshold value.

The greater the speed of the own vehicle immediately before the own vehicle enters an uphill, the greater the kinetic energy of the own vehicle at that time. As such, when the kinetic energy immediately before the own vehicle starts climbing the uphill is relatively large, by using the kinetic energy as energy for starting to climb the uphill, the own vehicle can start climbing the uphill smoothly (without being rapidly decelerated). Therefore, in this case, the driver does not need to maintain a state in which the accelerator pedal is deeply depressed for so long. Also, in this case (when the speed of the own vehicle immediately before the own vehicle starts climbing the uphill is relatively high), a risk increases that, due to an erroneous depression of the accelerator pedal, the own vehicle rapidly approaches the preceding moving body and the own vehicle and the preceding moving body come into contact.

A processor of the vehicle control device according to this aspect allocates a smaller value to the erroneous operation determination threshold value (a delay time of a start timing of the drive torque limitation process) as the speed of the own vehicle at the time when the gradient difference is acquired becomes greater. That is, according to the vehicle control device of this aspect, the start timing of the drive torque limitation process is adjusted according to the speed of the own vehicle immediately before the own vehicle enters the uphill.

In a vehicle control device according to another aspect of the present invention, a plurality of maps (ML/MS) respectively designed according to magnitudes of maximum outputs of drive devices re provided, the plurality of maps indicating a relationship between the gradient difference and a threshold value of the continuation time, and including the map corresponding to the magnitude of the maximum output of the drive device of the own vehicle, and the processor is configured to determine the erroneous operation determination threshold value by referring to the map.

A maximum output of a drive device of a vehicle (torque generated by the drive device in a state where a depression depth of an accelerator pedal is maximum (100%)) differs for each vehicle model (vehicle specification). When the maximum output of the drive device is relatively large, a drive torque applied to drive wheels of the own vehicle due to an erroneous depression of the accelerator pedal is large, so that the own vehicle is rapidly accelerated and the own vehicle and a preceding moving body rapidly approach each other, increasing a risk that the own vehicle comes into contact with the preceding moving body. Therefore, in this case (when the maximum output of the drive device is relatively large), it is preferable not to delay a start timing of the drive torque limitation process very much in the uphill entry scene. Accordingly, the vehicle control device according to this aspect uses, among a plurality of types of maps corresponding to magnitudes of the maximum output of the drive device, a map corresponding to a specification (the maximum output of the drive device) of the drive device of the own vehicle. As a result, a value optimal for the maximum output of the drive device of the own vehicle is allocated to the erroneous operation determination threshold value. Note that, compared to the erroneous operation determination threshold value in a case where the maximum output of the drive device is relatively small, where a speed is “σ” and a gradient difference is “θ,” it is preferable that the erroneous operation determination threshold value in a case where the maximum output is relatively large, where the speed is “σ” and the gradient difference is “θ,” is smaller.

### BRIEF DESCRIPTION OF THE DRAWINGS

FIG. 1 is a block diagram of a vehicle control device according to one embodiment of the present invention.

FIG. 2 is a timing chart showing changes in a depression depth of an accelerator pedal, changes in a gradient difference, a start timing of a drive torque limitation process, and the like.

FIG. 3 is an example of a map showing a relationship among a speed of an own vehicle, a gradient difference, and a threshold value of a continuation time of a state in which the depression depth of the accelerator pedal exceeds a threshold value (the start timing of the drive torque limitation process).

FIG. 4 is an example of a map used when a maximum output of a drive device is large and a map used when the maximum output of the drive device is small.

FIG. 5 is a flowchart of a first program executed by a CPU to realize a drive torque limitation function.

FIG. 6 is a flowchart of a second program executed by a CPU to realize the drive torque limitation function.

### DESCRIPTION OF THE EMBODIMENTS

### Outline

A vehicle control device 1 according to one embodiment of the present invention is applied to a vehicle V0 having an automated driving function (hereinafter referred to as an “own vehicle”). The vehicle control device 1 includes a drive torque limitation function that, in a state where the automated driving function is invalidated (a state in which a driver is mainly performing driving operations), when predetermined conditions (conditions for determining that an accelerator pedal is erroneously depressed) are satisfied, controls a drive device and the like such that a torque of drive wheels becomes equal to or less than a predetermined value. Further, the vehicle control device 1 includes a delay function that, in a scene where the own vehicle enters an uphill (a scene where a road surface gradient increases), delays an activation start timing of the drive torque limitation function.

### Specific Configuration

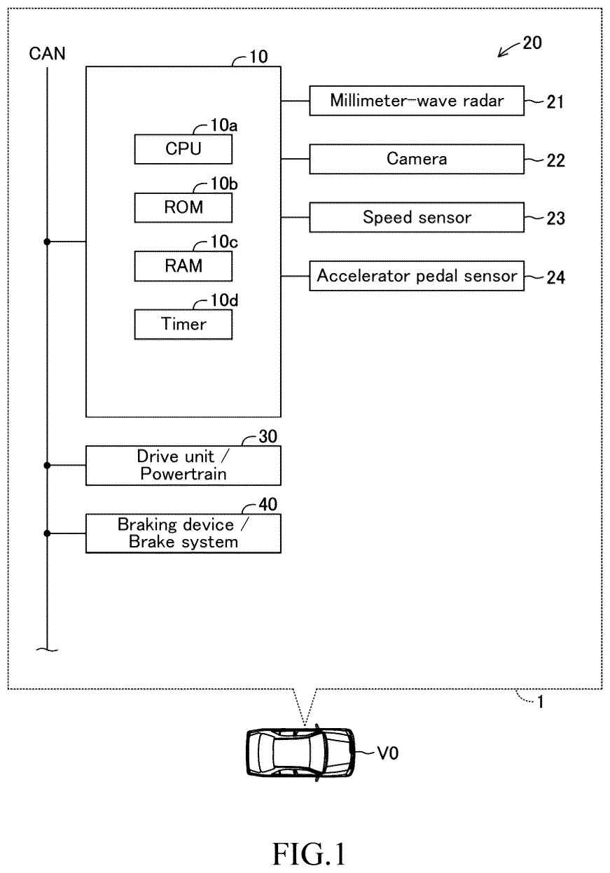

As shown in FIG. 1, the vehicle control device 1 includes an ECU 10, an in-vehicle sensor 20, a drive device 30, and a braking device 40.

The ECU 10 includes a microcomputer including a CPU 10a, a ROM 10b, a RAM 10c, a timer 10d, and the like. The ECU 10 is connected to other ECUs via a CAN (communication network).

The in-vehicle sensor 20 includes a millimeter-wave radar 21, a camera 22, a speed sensor 23, and an accelerator pedal sensor 24.

The millimeter-wave radar 21 includes a transmitting/receiving unit and a signal processing unit (not shown). The transmitting/receiving unit radiates electromagnetic waves in a millimeter-wave band (hereinafter referred to as “millimeter waves”) to a periphery of the own vehicle and receives millimeter waves (reflected waves) reflected by a solid object (for example, a preceding vehicle) located within a radiation range. The signal processing unit calculates, based on a time from when the transmitting/receiving unit radiates the millimeter waves until the reflected waves are received, a phase difference between the radiated millimeter waves and the received reflected waves, an attenuation level of the reflected waves, and the like, a distance between the own vehicle and the solid object, a direction of the solid object with respect to the own vehicle, a speed of the solid object with respect to the own vehicle, and the like, and provides the calculation result (target information) to the ECU 10.

The camera 22 includes an imaging device. The imaging device incorporates, for example, an imaging element such as a CCD (charge coupled device) or a CIS (CMOS image sensor). The imaging device is installed, for example, on a front portion of the own vehicle. Each imaging device captures a front area of the own vehicle at a predetermined frame rate to acquire image data. The camera 22 further includes an image analysis device. The image analysis device sequentially acquires image data from each imaging device. The image analysis device analyzes the acquired image data and acquires, from the image, information regarding a target located around the own vehicle. For example, the image analysis device identifies (recognizes) a type of a target located in front of the own vehicle (for example, a tail lamp of a preceding vehicle) and provides an identification result (for example, a position (coordinates) of the tail lamp of the preceding vehicle in the acquired image) to the ECU 10.

The speed sensor 23 detects a rotational speed (wheel speed) of each wheel, calculates, based on each wheel speed, a speed sp0 (measured value) of the own vehicle, and provides the calculation result to the ECU 10.

The accelerator pedal sensor 24 detects a depression depth AD (accelerator opening degree) of the accelerator pedal and provides the detection result to the ECU 10.

The drive device 30 applies drive torque to the drive wheels. The drive device 30 includes an engine ECU, an internal combustion engine, a transmission, and a transmission mechanism that transmits torque of an output shaft of the transmission to the drive wheels. The engine ECU acquires, from another ECU (the ECU 10), information (a target value) indicating a target drive torque. The engine ECU drives an actuator of a throttle valve of the internal combustion engine so that the drive torque applied to the drive wheels matches the target value.

When a vehicle to which the vehicle control device 1 is applied is a hybrid electric vehicle (HEV), the engine ECU can adjust an output (drive torque) of either one or both of an “internal combustion engine and an electric motor” as a vehicle drive source. When a vehicle to which the vehicle control device 1 is applied is a battery electric vehicle (BEV), instead of the engine ECU, a motor ECU that adjusts an output (drive torque) of an “electric motor” as a vehicle drive source is used.

The braking device 40 applies a braking force to wheels (brake discs). The braking device 40 includes a brake ECU and a brake caliper. The brake caliper includes an actuator that presses a brake pad against the brake disc. The brake ECU acquires, from another ECU, information (a target value) indicating a target braking force. The brake ECU drives the actuator of the brake caliper so that the braking force applied to the wheels (the brake discs) matches the target value.

### Operation

The vehicle control device 1 includes a function (drive torque limitation function) that, when the accelerator pedal is erroneously depressed, controls the drive device 30 and/or the braking device 40 such that a drive torque applied to the drive wheels is limited to a predetermined value or less.

### Drive Torque Limitation Function

In a state where a speed sp0 of an own vehicle is relatively small (for example, 10 km/h or less (immediately after starting from a stopped state of the own vehicle)), it is rare that, even though a preceding vehicle (or a pedestrian, bicycle, or the like (preceding moving body)) is present, a driver of the own vehicle maintains a state in which the accelerator pedal is deeply depressed and continues to accelerate the own vehicle. That is, in this case, there is a high possibility that the driver is erroneously depressing the accelerator pedal. Therefore, the ECU 10 sequentially determines validity of the following conditions X (conditions X1 to X3) and condition Y based on information acquired from the in-vehicle sensor 20.
(X1) . . . The speed sp0 of the own vehicle is equal to or less than a threshold sp0th.
(X2) . . . A distance Δd between the own vehicle and the preceding moving body is equal to or less than a threshold Δdth.
(X3) . . . A depression depth AD of the accelerator pedal exceeds a threshold ADth.
(Y) . . . A continuation time Δt of a state in which conditions X1, X2, and X3 are satisfied exceeds a threshold Δtth (erroneous operation determination threshold). When condition Y is satisfied, the ECU 10 determines that the accelerator pedal of the own vehicle is erroneously depressed. Then, in this case, the ECU 10 controls the drive device 30 such that a drive torque applied to drive wheels of the own vehicle is equal to or less than a predetermined value (drive torque limitation process). For example, the ECU 10 controls an actuator of a throttle valve such that an output of the drive device 30 becomes “0” as the drive torque limitation process.

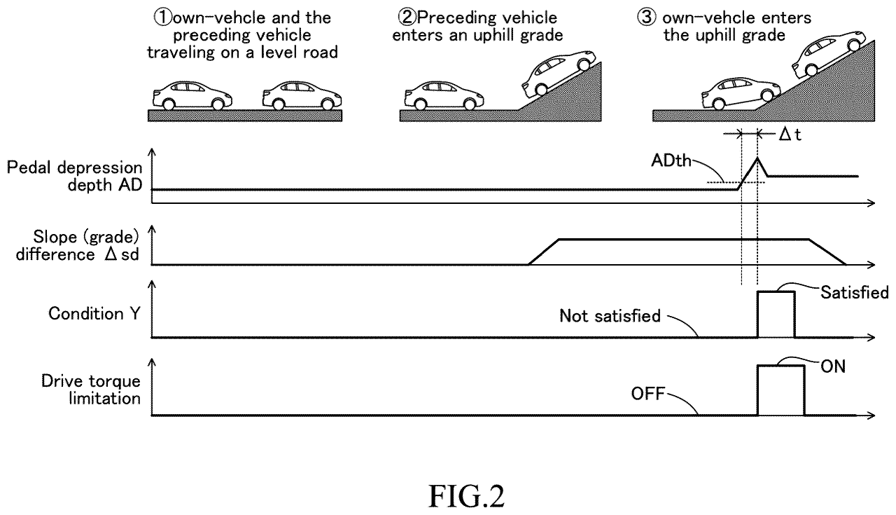

Meanwhile, as described above, in the uphill entry scene, there is a high possibility that the driver intentionally maintains a state in which the accelerator pedal is relatively deeply depressed so that sufficient torque is applied to the drive wheels for the own vehicle to start climbing the uphill. In this scene, it is preferable that the torque applied to the drive wheels is not limited to a predetermined value or less. Therefore, as described below, the ECU 10 has a function of delaying a start timing of execution of the drive torque limitation process (a function of prohibiting execution of the drive torque limitation process within a predetermined period after the driver has deeply depressed the accelerator pedal) in the uphill entry scene (see FIG. 2).

### Delay Function

The ECU 10 sequentially acquires, based on information acquired from the in-vehicle sensor 20, a difference (gradient difference Δsd) between a road surface gradient at a current position and a road surface gradient at a position slightly ahead. As a method for acquiring the gradient difference Δsd, for example, a method disclosed in Japanese Unexamined Patent Application Publication No. 2012-088217 can be employed. That is, the ECU 10 sequentially acquires, from the camera 22, positions (coordinates in a vertical axis direction of an image) of tail lamps of a preceding vehicle in images obtained by photographing a front area of the own vehicle. Then, the ECU 10 acquires the gradient difference Δsd based on the positions of the tail lamps in the images (and a distance between the own vehicle and the preceding vehicle acquired from the millimeter-wave radar 21). Note that, when a pedestrian or a bicycle as a preceding moving body exists in front of the own vehicle, the ECU 10 may acquire the gradient difference Δsd based on coordinates of a head of a driver of the pedestrian or the bicycle in the image.

Here, the larger the gradient difference Δsd, the larger energy (drive torque ×time (integral value of the drive torque)) that needs to be generated from the drive device for the own vehicle to start climbing the uphill. However, the greater a speed sp0 of the own vehicle immediately before the own vehicle enters the uphill, the greater kinetic energy of the own vehicle at that time. As such, when the kinetic energy immediately before the own vehicle starts climbing the uphill is relatively large, by using the kinetic energy as energy for starting to climb the uphill, the own vehicle can start climbing the uphill smoothly (without being rapidly decelerated). Therefore, in this case, the driver does not need to maintain a state in which the accelerator pedal is deeply depressed for so long. Also, in this case (when the speed sp0 of the own vehicle immediately before the own vehicle starts climbing the uphill is relatively high), due to an erroneous depression of the accelerator pedal, the own vehicle may rapidly approach the preceding moving body, thereby increasing a risk that the own vehicle comes into contact with the preceding moving body.

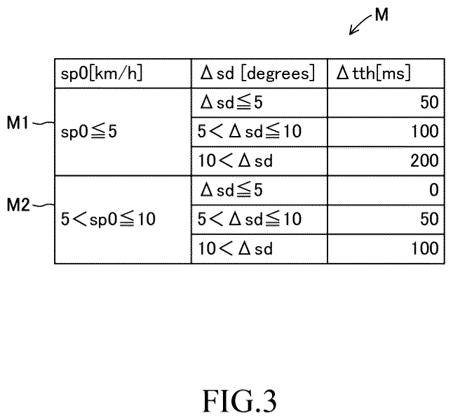

Accordingly, the ECU 10 determines a start timing of the drive torque limitation process in accordance with not only the gradient difference Δsd but also the speed sp0. Specifically, as shown in FIG. 2, a map M indicating a relationship among the speed sp0, the gradient difference Δsd, and the threshold Δtth is stored in the ROM 10b, and the ECU 10 determines a value to be allocated to the threshold Δtth by referring to the map M. For example, as shown in FIG. 3, the map M is composed of a map M1 used when the speed sp0 is relatively small and a map M2 used when the speed sp0 is relatively large. As shown in the figure, the map M is designed such that the larger the gradient difference Δsd, the larger a value allocated to the threshold Δtth, and the greater the speed sp0, the smaller a value allocated to the threshold Δtth. That is, for example, compared to the threshold Δtth in a case (first example) where the speed sp0 is “5 (km/h)” or less and the gradient difference Δsd is “5 (deg)” or less, the threshold Δtth in a case (second example) where the speed sp0 is “5 (km/h)” or less as in the first example and the gradient difference Δsd exceeds “10 (deg)” is larger. Further, for example, compared to the threshold Δtth in a case (third example) where the gradient difference Δsd is “5 (deg)” or less and the speed sp0 is “5 (km/h)” or less, the threshold Δtth in a case (fourth example) where the gradient difference Δsd is “5 (deg)” or less as in the third example and the speed sp0 exceeds “5 (km/h)” is smaller. Note that the map in FIG. 3 is an example, and the speed sp0 and the gradient difference Δsd may be further subdivided.

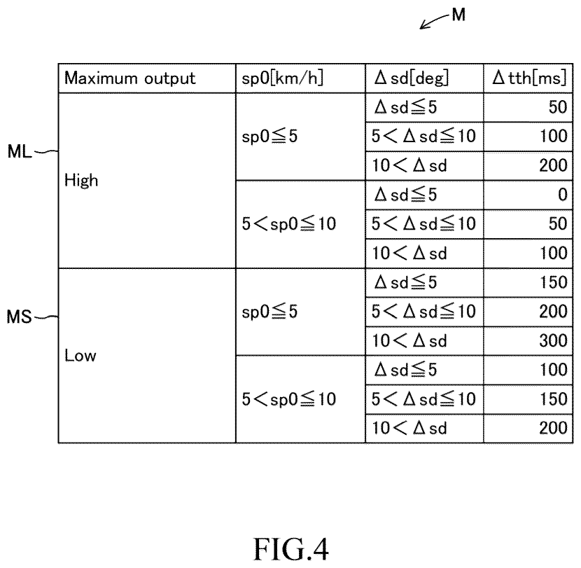

Meanwhile, a maximum output of a drive device of a vehicle (torque generated by the drive device in a state where a depression depth of an accelerator pedal is maximum (100%)) differs for each vehicle model (vehicle specification). When the maximum output of the drive device is relatively large, a drive torque applied to drive wheels of the own vehicle due to an erroneous depression of the accelerator pedal is large, so that the own vehicle is rapidly accelerated and the own vehicle and a preceding vehicle rapidly approach each other, increasing a risk that the own vehicle comes into contact with the preceding vehicle. Therefore, in this case (when the maximum output of the drive device is relatively large), it is preferable not to delay the start timing of the drive torque limitation process very much in the uphill entry scene. Accordingly, as shown in FIG. 4, in a design stage of various types of vehicles, a plurality of types of maps (map ML/map MS) corresponding to magnitudes (large/small) of the maximum output of the drive device are designed, and among them, a map M (map ML/map MS) corresponding to a specification (the maximum output of the drive device 30) of the drive device 30 of the own vehicle is preferably stored in the ROM 10b. Note that, as shown in the figure, for example, compared to a threshold Δtth in a case (fifth example) where the maximum output Pmax is “small,” the speed sp0 is “5 (km/h)” or less, and the gradient difference Δsd is “5 (deg)” or less, a threshold Δtth in a case (sixth example) where the maximum output Pmax is “large,” the speed sp0 is “5 (km/h)” or less as in the fifth example, and the gradient difference Δsd is “5 (deg)” or less, is smaller.

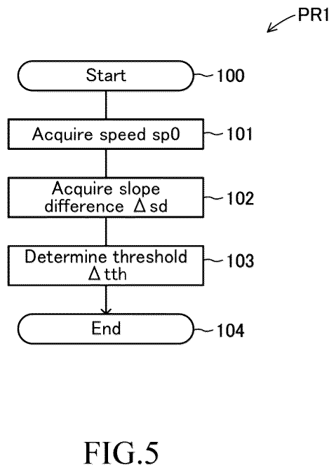

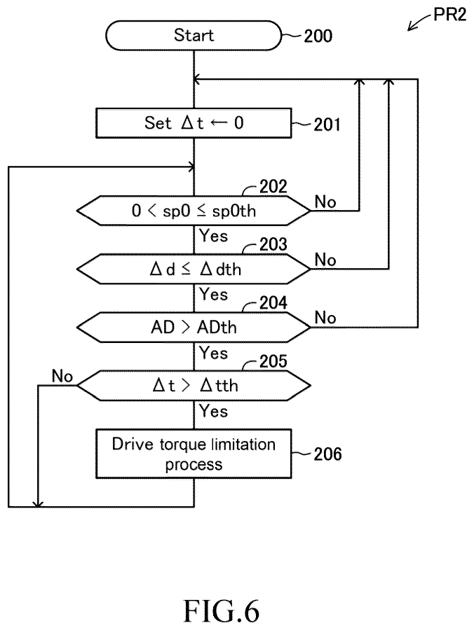

Next, with reference to FIGS. 5 and 6, programs PR1 and PR2 executed by the CPU 10a (hereinafter simply referred to as “CPU”) of the ECU 10 to realize functions (the drive torque limitation function and the delay function) of the vehicle control device 1 will be described. The CPU executes the program PR1 at a predetermined cycle when an ignition switch is in an on state. The CPU starts execution of the program PR2 when the CPU detects that the ignition switch has transitioned from an off state to an on state.

### Program Pr1

The CPU starts execution of the program PR1 from step 100 and proceeds to step 101.

In step 101, the CPU acquires the speed sp0 of the own vehicle from the speed sensor 23. Then, the CPU proceeds to step 102.

In step 102, the CPU acquires the gradient difference Δsd based on information acquired from the camera 22. Then, the CPU proceeds to step 103.

In step 103, the CPU refers to the map M (FIG. 3), acquires a value (delay time) corresponding to the speed sp0 and the gradient difference Δsd, and allocates the value to the threshold Δtth. Then, the CPU proceeds to step 104.

In step 104, the CPU terminates execution of the program PR1.

### Program PR2

The CPU starts execution of the program PR2 from step 200 and proceeds to step 201.

In step 201, the CPU causes the timer 10d to reset its output (measurement result of a time Δt) (sets the time Δt to “0”) and start measurement of the time Δt. Then, the CPU proceeds to step 202.

In step 202, the CPU determines whether or not the speed sp0 of the own vehicle is included in a predetermined low speed range (validity of condition X1 (0<sp0≤sp0th)). When the CPU determines that the speed sp0 is included in the predetermined low speed range (202: Yes), the CPU proceeds to step 203. On the other hand, when the CPU determines that the speed sp0 is not included in the predetermined low speed range (202: No), the CPU returns to step 201.

In step 203, the CPU determines whether or not a distance Δd between the own vehicle and a preceding vehicle is equal to or less than a threshold Δdth (validity of condition X2 (Δd≤Δdth)). When the CPU determines that the distance Δd is equal to or less than the threshold Δdth (203: Yes), the CPU proceeds to step 204. On the other hand, when the CPU determines that the distance Δd is not equal to or less than the threshold Δdth (203: No), the CPU returns to step 201.

In step 204, the CPU determines whether or not a depression depth AD of the accelerator pedal exceeds a threshold ADth (validity of condition X3 (AD>ADth)). When the CPU determines that the depression depth AD exceeds the threshold ADth (204: Yes), the CPU proceeds to step 205. On the other hand, when the CPU determines that the depression depth AD does not exceed the threshold ADth (204: No), the CPU returns to step 201.

In step 205, the CPU determines whether or not an output (the time Δt) of the timer 10d exceeds the threshold Δtth (validity of condition Y (Δt>Δtth)). When the CPU determines that the time Δt exceeds the threshold Δtth (205: Yes), the CPU proceeds to step 206. On the other hand, when the CPU determines that the time Δt does not exceed the threshold Δtth (205: No), the CPU returns to step 202.

In step 206, the CPU executes the drive torque limitation process. Then, the CPU returns to step 202.

### Effect

When a speed of an own vehicle is relatively low and a distance between the own vehicle and a preceding vehicle is relatively small, and a state in which an accelerator pedal is deeply depressed continues for a long time, there is a high possibility that a driver is erroneously depressing the accelerator pedal. Therefore, in this case, the ECU 10 of the vehicle control device 1 according to the present embodiment executes the drive torque limitation process. As a result, the own vehicle is suppressed from excessively approaching the preceding vehicle. Here, when the own vehicle starts climbing an uphill, there is a high possibility that the driver intentionally deeply depresses the accelerator pedal. In particular, when a gradient difference is relatively large, there is a high possibility that the driver considerably deeply depresses the accelerator pedal and maintains that state for a relatively long time (for example, several tens of milliseconds to several hundreds of milliseconds). Therefore, in the scene where the own vehicle enters the uphill, the ECU 10 of the vehicle control device 1 according to the present invention allocates a larger value to the threshold Δtth as the gradient difference Δsd becomes larger. That is, a start timing of the drive torque limitation process is adjusted according to the gradient difference. And the larger the gradient difference, the larger a value allocated to a delay time of the start timing of the drive torque limitation process. As a result, at a time when the own vehicle starts climbing the uphill (a time when the driver intentionally deeply depresses the accelerator pedal and immediately thereafter), execution of the drive torque limitation process contrary to the driver's intention is suppressed.

### Modified Example

In the above embodiment, the ECU 10 acquires the gradient difference Δsd based on a position (a vertical coordinate) of a tail lamp of a preceding vehicle in an image acquired by the camera 22. Instead of this (or in addition to this), the ECU 10 may acquire an elevation of a current position of the own vehicle and an elevation of a position slightly ahead of the own vehicle (a current position of the preceding vehicle) from, for example, a navigation system (map data) (not shown), and acquire the gradient difference Δsd based on these elevations.

### Modified Example 2

In the above embodiment, the ECU 10 determines that the condition X3 is satisfied when a depression depth AD of the accelerator pedal exceeds a threshold ADth. Instead of this, the ECU 10 may determine that the condition X3 is satisfied when an increase rate ADr of the depression depth of the accelerator pedal exceeds a threshold ADrth.

1. A vehicle control device comprising:
a surrounding sensor configured to acquire information relating to a distance between a preceding moving body and an own vehicle, information relating to a speed of the own vehicle, and information relating to a depression operation of an accelerator pedal of the own vehicle; and
a processor configured to, in a situation where the speed of the own vehicle is equal to or less than a threshold value and the distance between the own vehicle and the preceding moving body is equal to or less than a threshold value, when a continuation time of a state in which a depression depth of the accelerator pedal or an increase rate thereof exceeds a threshold value exceeds a predetermined erroneous operation determination threshold value, control a drive device and/or a braking device such that a drive torque applied to drive wheels of the own vehicle is limited to a predetermined value or less,
wherein the surrounding sensor includes a sensor for acquiring a gradient difference which is a difference between a gradient of a region where the preceding moving body is located and a gradient of a region where the own vehicle is located, the gradients being of a road surface in a traveling direction of the own vehicle and the preceding moving body, and
wherein the processor is configured such that, in a scene where the own vehicle enters an uphill road, the larger the gradient difference, the larger a value allocated to the erroneous operation determination threshold value.

2. A vehicle control device according to claim 1,
wherein the processor is configured such that, in the scene, the greater the speed of the own vehicle at the time of acquiring the gradient difference, the smaller a value allocated to the erroneous operation determination threshold value.

3. A vehicle control device according to claim 1,
comprising a plurality of maps respectively designed according to a magnitude of a maximum output of drive devices, the maps indicating relationships between the gradient difference and the erroneous operation determination threshold value, and including the map corresponding to the magnitude of the maximum output of the drive device of the own vehicle,
wherein the processor is configured to determine the erroneous operation determination threshold value by referring to the map.
